(19) United States
(12) Patent Application Publication
(10) Pub. No.: US 2011/0317261 A1
(43) Pub. Date: Dec. 29, 2011

(54) Light source device and stereoscopic display apparatus

(75) Inventors: Masaru MINAMI, Kanagawa (JP); Tetsuro KUWAYAMA, Chiba (JP)

(73) Assignee: Sony Corporation, Tokyo (JP)

(21) Appl. No.: 13/064,786

(22) Filed: Apr. 15, 2011

(30) Foreign Application Priority Data
Jun. 25, 2010 (JP) 2010-144972

(51) Int. Cl. G02B 27/22; F21V 13/00

(52) U.S. Cl. 359/462; 362/607

(57) ABSTRACT

A light source device includes: a light-guiding plate having a first inner reflective surface and a second inner reflective surface which faces the first inner reflective surface, the second inner reflective surface including a transparent region which causes total internal reflection of the first illumination light and allows the second illumination light to pass therethrough, and including a scattering region causing scatter reflections of the first illumination light; a first light source emitting first illumination light to allow the first illumination light to enter the light-guiding plate from a side surface thereof; a parallax barrier disposed to face the second inner reflective surface of the light-guiding plate; and a second light source disposed to face the second inner reflective surface of the light-guiding plate with the parallax barrier in between, and emitting second illumination light.

### BACKGROUND OF THE INVENTION

1. Field of the Invention

The present invention relates to a light source device and a stereoscopic display apparatus which allow stereoscopic vision by a parallax barrier system.

2. Description of the Related Art

In related art, there is known a stereoscopic display apparatus employing a parallax barrier system that is one of stereoscopic display systems allowing stereoscopic vision with the naked eye without wearing of special glasses. FIG. 9 illustrates a general configurational example of the stereoscopic display apparatus employing the parallax barrier system. In this stereoscopic display apparatus, a parallax barrier 101 is disposed in front of and opposite a two-dimensional display panel 102. In a general configuration of the parallax barrier 101, barrier sections 111 which block display image light coming from the two-dimensional display panel 102 and stripe-shaped opening sections (slits) 112 which pass the display image light are arranged alternately in a horizontal direction.

On the two-dimensional display panel 102, an image based on three-dimensional image data is displayed. For example, parallax images varying in parallax information are prepared as the three-dimensional image data, and, for example, stripe-shaped divisional images which extend vertically are cut out from each of the parallax images. The divisional images are alternately arranged in a horizontal direction for each of the parallax images, and thereby a composite image including stripe-shaped parallax images is generated within a single screen, and the composite image is displayed on the two-dimensional display panel 102. In the case of the parallax barrier system, the composite image displayed on the two-dimensional display panel 102 is observed through the parallax barrier 101. The width of the divisional image to be displayed, a slit width in the parallax barrier 101, and the like are appropriately set, so that when an observer views the stereoscopic display apparatus from predetermined position and direction, the light of the different parallax images is allowed to enter a left eye 10L and a right eye 10R of the observer through the slits 112 separately. In this way, the stereoscopic image is perceived when the observer views the stereoscopic display apparatus from the predetermined position and direction. In order to realize the stereoscopic vision, it is desirable that the left eye 10L and the right eye 10R see different parallax images and thus, at least two parallax images, i.e. a right-eye image and a left-eye image are necessary. When three or more parallax images are used, multiple vision may be realized. A larger number of parallax images allow implementation of stereoscopic vision more appropriately responding to a change in the viewpoint position of the observer. In other words, motion parallax is achieved.

In the configurational example of FIG. 9, the parallax barrier 101 is disposed in front of the two-dimensional display panel 102. However, in a case where, for example, a transmissive liquid-crystal display panel is used, a configuration in which the parallax barrier 101 is disposed behind the two-dimensional display panel 102 may be provided (see FIG. 3 of Japanese Unexamined Patent Application Publication No. 2007-187823). In this case, the parallax barrier 101 is disposed between the transmissive liquid-crystal display panel and a backlight, so that stereoscopic display may be performed based on a principle similar to that of the configurational example in FIG. 9.

### SUMMARY OF THE INVENTION

Among stereoscopic display apparatuses like the one described above, there has been developed an apparatus that may not only perform three-dimensional display, but also may switch to usual two-dimensional display as needed. For example, FIG. 3 of Japanese Unexamined Patent Application Publication No. 2007-187823 illustrates a configuration in which as a backlight, a first light source and a first light-guiding plate, and a second light source and a second light-guiding plate are provided, and a parallax barrier is disposed between the first light-guiding plate and the second light-guiding plate. In this configuration described in Japanese Unexamined Patent Application Publication No. 2007-187823, two-dimensional display is performed by using the first light source and the first light-guiding plate, and three-dimensional display is performed by using the second light source, the second light-guiding plate and the parallax barrier. In other words, switching between the two-dimensional display and the three-dimensional display is performed by switching between the two light sources selectively.

In this configuration described in Japanese Unexamined Patent Application Publication No. 2007-187823, switching between the two-dimensional display and the three-dimensional display is realized by using a semi-transmissive member as the first light-guiding plate. For this reason, for example, when a reflection coating in which the transmittance of the semi-transmissive member is 50% is used, the utilization rate of light by the first and second light-guiding plates is 50% and thus, an efficiency of utilization of the light is reduced. Further, for example, when micro scattering particles are contained as the semi-transmissive member, light transmitting the second light-guiding plate and the parallax barrier and having directivity scatters in the first light-guiding plate, which causes a disadvantage such as a deterioration of three-dimensional display quality.

In view of the foregoing, it is desirable to provide a light source device and a stereoscopic display apparatus which may switch between two-dimensional display and three-dimensional display, while preventing a fall in the utilization rate of light, without causing a deterioration of image quality.

A light source device according to an embodiment of the present invention includes: a light-guiding plate having a first inner reflective surface and a second inner reflective surface which faces the first inner reflective surface, the second inner reflective surface including a transparent region which causes total internal reflection of the first illumination light and allows the second illumination light to pass therethrough, and including a scattering region causing scatter reflections of the first illumination light; a first light source emitting first illumination light to allow the first illumination light to enter the light-guiding plate from a side surface thereof; a parallax barrier disposed to face the second inner reflective surface of the light-guiding plate; and a second light source disposed to face the second inner reflective surface of the light-guiding plate with the parallax barrier in between, and emitting second illumination light.

A stereoscopic display apparatus according to an embodiment of the present invention includes a display section performing image display; and a light source device emitting light for the image display toward the display section, and this light source device is configured by using the light source device according to the above-described embodiment of the present invention.

In the light source device or the stereoscopic display apparatus according to the embodiment of the present invention, the first illumination light by the first light source is scattered in the scattering region at the second inner reflective surface of the light-guiding plate, and thereby allowed to go outside the light-guiding plate from the first inner reflective surface. On the other hand, the second illumination light by the second light source passes through the transparent region at the second inner reflective surface, and thereby allowed to go outside the light-guiding plate from the first inner reflective surface.

Therefore, by providing the transparent region at the position corresponding to the opening section of the parallax barrier and performing on-off control of the first light source and the second light source appropriately, illumination light for two-dimensional display and illumination light for three-dimensional display are obtained. Specifically, when the three-dimensional display is performed, the first light source is OFF and the second light source is ON. In this case, the second illumination light passing through the opening section of the parallax barrier passes through the transparent region of the light-guiding plate as it is as rays having directivity, and goes outside the light-guiding plate. In addition, when the two-dimensional display is performed, the first light source is ON and the second light source is OFF or ON. In this case, at least the first illumination light by the first light source is scattered in the scattering region, and thereby allowed to go outside the light-guiding plate from the almost entire first inner reflective surface.

In the light source device or the stereoscopic display according to the above-described embodiment of the present invention, the scattering region and the transparent region are provided in the second inner reflective surface of the light-guiding plate, and the first illumination light by the first light source and the second illumination light by the second light source are selectively allowed to go outside the light-guiding plate. Therefore, the illumination light for the two-dimensional display and the illumination light for three-dimensional display may be selectively obtained, while a drop in a utilization rate of light is prevented. This allows switching between the two-dimensional display and the stereoscopic display, while a fall in the utilization rate of light, without causing a deterioration of display quality.

### BRIEF DESCRIPTION OF THE DRAWINGS

FIG. 1 is a cross-sectional diagram illustrating a configurational example of a light source device and a stereoscopic display apparatus according to an embodiment of the present invention;

FIG. 2 is an explanatory diagram schematically illustrating an emission state of rays from the light source device when only a second light source is in an ON (lighting) state, in the stereoscopic display apparatus illustrated in FIG. 1;

FIG. 3 is an explanatory diagram schematically illustrating a reflected state and a scattered state of rays inside a light-guiding plate when a first light source is in an ON (lighting) state;

FIG. 4A and FIG. 4B are a cross-sectional diagram illustrating a first configurational example of a surface of the light-guiding plate in the stereoscopic display illustrated in FIG. 1, and an explanatory diagram schematically illustrating a reflected state and a scattered state of rays in the surface of the light-guiding plate illustrated in FIG. 4A, respectively;

FIG. 5A and FIG. 5B are a cross-sectional diagram illustrating a second configurational example of the surface of the light-guiding plate in the stereoscopic display illustrated in FIG. 1, and an explanatory diagram schematically illustrating a reflected state and a scattered state of rays in the surface of the light-guiding plate illustrated in FIG. 5A, respectively;

FIG. 6A and FIG. 6B are a cross-sectional diagram illustrating a third configurational example of the surface of the light-guiding plate in the stereoscopic display illustrated in FIG. 1, and an explanatory diagram schematically illustrating a reflected state and a scattered state of rays in the surface of the light-guiding plate illustrated in FIG. 6A, respectively;

FIG. 7 is an explanatory diagram schematically illustrating an outgoing state of rays from the light source device when both the first light source and the second light source are in the ON (lighting) state, in the stereoscopic display apparatus illustrated in FIG. 1;

FIG. 8 is a characteristic diagram illustrating an example of a luminance distribution observed when the ON (lighting) and OFF (non-lighting) states of the first light source and the second light source are variously changed in the light source device illustrated in FIG. 1; and

FIG. 9 is a block diagram illustrating a general configurational example of a stereoscopic display apparatus employing a parallax barrier system.

### DETAILED DESCRIPTION OF THE PREFERRED EMBODIMENTS

An embodiment of the present invention will be described below in detail with reference to the drawings.

### [Entire Configuration of Stereoscopic Display Apparatus]

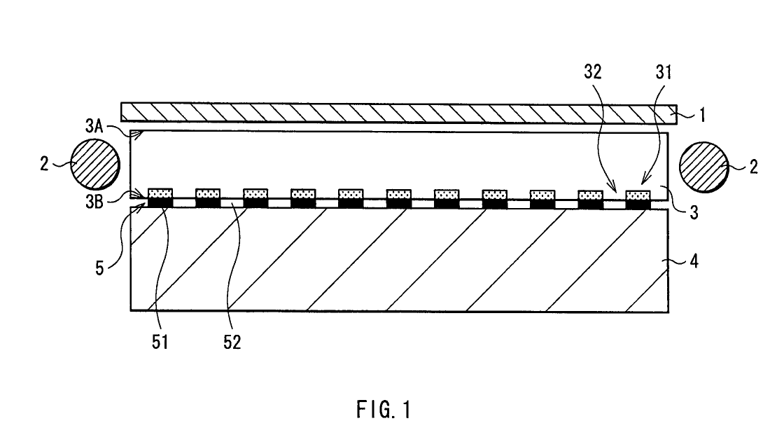

FIG. 1 illustrates a configurational example of a stereoscopic display apparatus according to an embodiment of the present invention. This stereoscopic display apparatus includes a display section 1 performing image display and a light source device disposed behind the display section 1 and emitting light for the image display to the display section 1. The light source device includes a first light source 2, a light-guiding plate 3, a second light source 4 and a parallax barrier 5. The light-guiding plate 3 has a first inner reflective surface 3A located opposite the display section 1 and a second inner reflective surface 3B located opposite the second light source 4. Incidentally, the stereoscopic display apparatus includes other elements such as a control circuit for the display section 1 used for display, but they are configured like general elements such as a general control circuit or the like for display and thus will not be described. In addition, although the illustration is not provided, the light source device includes a control circuit that performs on-off (lighting and non-lighting) control of the first light source 2 and the second light source 4.

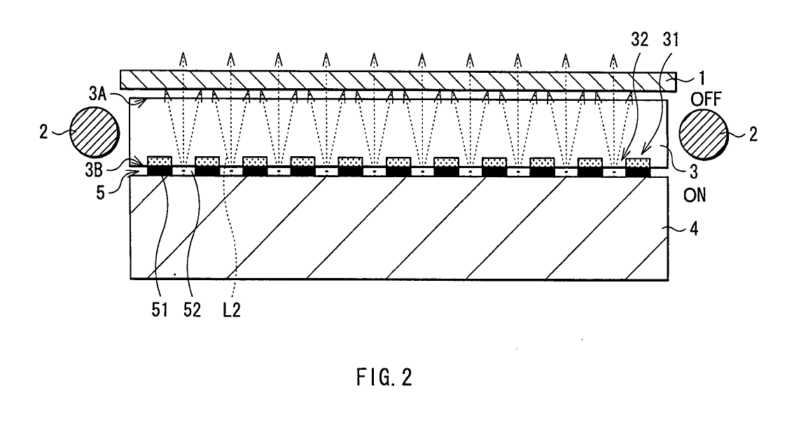

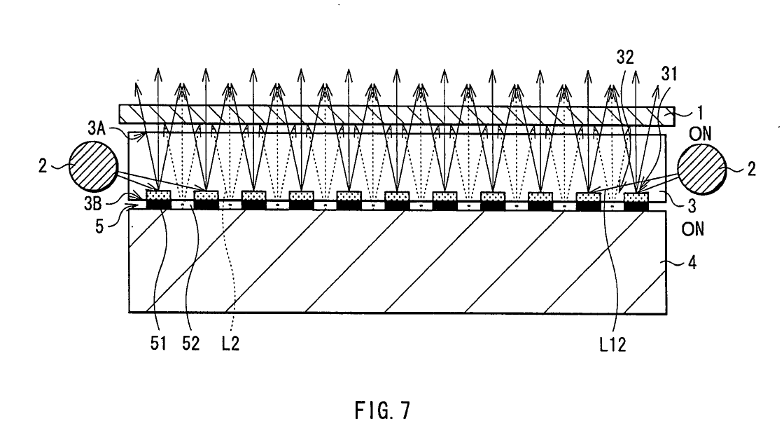

The stereoscopic display apparatus may selectively switch between a full-screen two-dimensional (2D) display mode and a full-screen three-dimensional (3D) display mode freely. The switching between the two-dimensional display mode and the three-dimensional display mode may be carried out by performing switching control of image data to be displayed in the display section 1 and on-off switching control of the first light source 2 and the second light source 4. FIG. 2 schematically illustrates an emission state of rays from the light source device when only the second light source 4 is in the ON (lighting) state, and this corresponds to the three-dimensional display mode. In addition, FIG. 7 schematically illustrates an emission state of rays from the light source device when both the first light source 2 and the second light source 4 are in the ON (lighting) state, and this corresponds to the two-dimensional display mode.

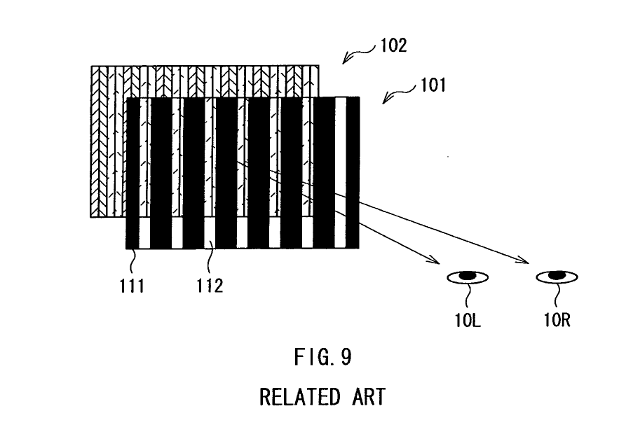

The display section 1 is configured by using a transmissive two-dimensional display panel, e.g., a transmissive liquid-crystal display panel, and includes, for example, a plurality of pixels including R (red) pixels, G (green) pixels and B (blue) pixels. These pixels are arranged in the form of a matrix. The display section 1 performs two-dimensional image display by modulating the light from the light source device for each pixel according to image data. The display section 1 displays an image based on three-dimensional image data and an image based on two-dimensional image data by selectively switching between these images freely. Incidentally, the three-dimensional image data is, for example, data including a plurality of parallax images corresponding to viewing-angle directions in the three-dimensional display. For example, when binocular three-dimensional display is performed, the three-dimensional image data is data representing parallax images for right-eye display and left-eye display. When the display in the three-dimensional display mode is performed, like the stereoscopic display apparatus employing the parallax barrier system in the past illustrated in FIG. 9, for example, a composite image in which stripe-shaped parallax images included in a single screen is generated and displayed.

The parallax barrier 5 is intended to generate rays with directivity allowing stereoscopic vision, as illumination light for the display section 1. The parallax barrier 5 has barrier sections 51 blocking the light and opening sections 52 allowing the light to pass therethrough. The parallax barrier 5 is formed, for example, by disposing a black substance blocking the light, a thin film-shaped metal member reflecting the light, or the like, as the barrier sections 51 on a transparent flat plate. In the present embodiment, any of various types of pattern known in the past may be used as an arrangement pattern (a barrier pattern) of the barrier sections 51 and the opening sections 52, and the arrangement pattern is not limited in particular. For example, there is known such a barrier pattern that in an effective region, the multiple opening sections 52 shaped like vertical slits are arranged horizontally in parallel with the barrier sections 51 interposed between the opening sections 52.

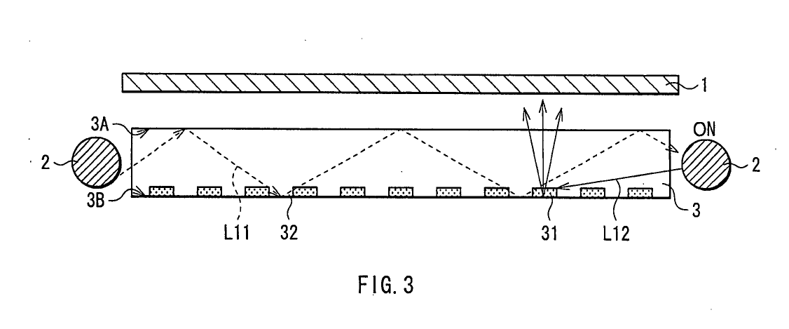

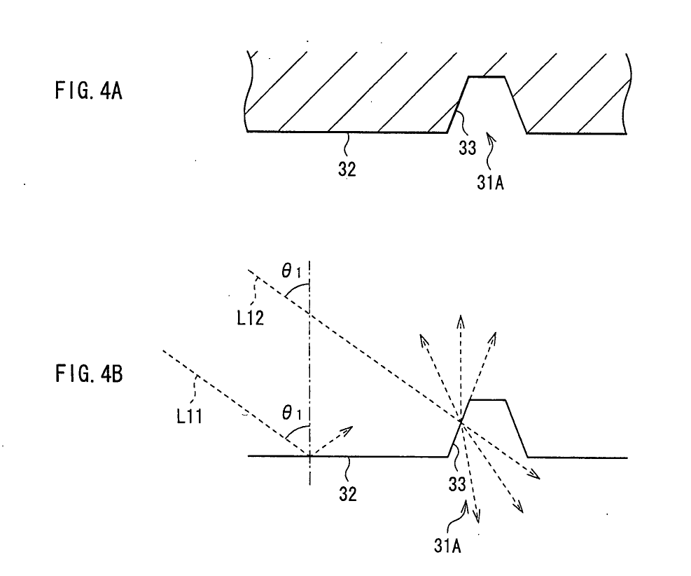

The first light source 2 is configured, for example, by using a fluorescent lamp such as CCFL (Cold Cathode Fluorescent Lamp) or an LED (Light Emitting Diode). The first light source 2 emits first illumination light L11 and L12 (FIG. 3 and FIG. 4) from a side direction toward the inside of the light-guiding plate 3. At least one first light source 2 is disposed on a side of the light-guiding plate 3. For example, when the planar shape of the light-guiding plate 3 is a rectangle, there are four side faces, but the first light source 2 may be disposed on at least one of the side faces. FIG. 1 illustrates the configurational example in which the first light source 2 is disposed on each of two opposed sides of the light-guiding plate 3. The on-off (lighting and non-lighting) control of the first light source 2 is performed according to the switching between the two-dimensional display mode and the three-dimensional display mode. Specifically, the first light source 2 is controlled to be OFF when an image based on the three-dimensional image data is displayed in the display section 1 (in the case of the three-dimensional display mode), and the first light source 2 is controlled to be in the ON when an image based on the two-dimensional image data is displayed in the display section 1 (in the case of the two-dimensional display mode).

The second light source 4 is disposed opposite the second inner reflective surface 3B of the light-guiding plate 3, with the parallax barrier 5 in between. The second light source 4 emits second illumination light L2 (FIG. 2 and FIG. 7) from the outside to the second inner reflective surface 3B. The second light source 4 is only desired to be a surface light source that emits light of uniform in-plane luminance, and its structure itself is not limited in particular, and a commercially available surface backlight may be used. For example, a structure in which a luminous body such as CCFL and LED and a light diffuser for making in-plane luminance uniform are used, or the like is conceivable. The on-off (lighting and non-lighting) control of the second light source 4 is performed according to the switching between the two-dimensional display mode and the three-dimensional display mode. Specifically, the second light source 4 is controlled to be in the ON when an image based on the three-dimensional image data is displayed in the display section 1 (in the case of the three-dimensional display mode), and the second light source 4 is controlled to be in the OFF or the ON when an image based on the two dimensions image data is displayed in the display section 1 (in the case of the two-dimensional display mode).

The light-guiding plate 3 is, for example, a transparent plastic plate made of acrylic resin or the like. In the light-guiding plate 3, the surface except the second inner reflective surface 3B is entirely transparent. For example, when the planar shape of the light-guiding plate 3 is a rectangle, the first inner reflective surface 3A and the four side faces are entirely transparent.

The entire surface of the first inner reflective surface 3A is subjected to specular working, and the first inner reflective surface 3A causes total internal reflection of rays entering at an incident angle meeting a total reflection condition, and allows rays which are out of the total reflection condition to go outside.

The second inner reflective surface 3B has scattering regions 31 and transparent regions 32. The transparent regions 32 are located at positions corresponding to the opening sections 52 of the parallax barrier 5, and the scattering regions 31 are located at positions corresponding to the barrier sections 51 of the parallax barrier 5. As will be described later, the scattering regions 31 are formed, for example, by subjecting the surface of the light-guiding plate 3 to laser processing, sandblasting, coating, or by affixing a sheet-like light scattering member to the surface of the light-guiding plate 3.

The first inner reflective surface 3A and the transparent regions 32 in the second inner reflective surface 3B cause total internal reflection of rays entering at an incident angle 01 meeting a total reflection condition (the total internal reflection of the rays entering at the incident angle θ1 larger than a predetermined critical angle a is caused). Thus, as illustrated in FIG. 3, the first illumination light L11 coming from the first light source 2 and entering at the incident angle θ1 meeting the total reflection condition is guided to the side face direction by the total internal reflection, between the first inner reflective surface 3A and the transparent regions 32 in the second inner reflective surface 3B. The transparent regions 32 also transmit the second illumination light L2 (FIG. 2 and FIG. 7) from the second light source 4, and allow the second illumination light L2 to advance toward the first inner reflective surface 3A as rays failing to meet the total reflection condition.

When the refractive index of the light-guiding plate 3 is assumed to be n1, and the refractive index of an outer medium (air layer) of the light-guiding plate 3 is assumed to be n0 (<n1), the critical angle a is expressed as follows. Each of α and θ1 is assumed to be an angle with respect to the normal of the surface of the light-guiding plate. The incident angle θ1 meeting the total reflection condition is θ1>α.
sinα=n0/n1

As illustrated in FIG. 3, the scattering regions 31 cause scatter reflections of the first illumination light L12 from the first light source 2, and allow at least part of the first illumination light L12 to go to the first inner reflective surface 3A as the rays with no satisfaction of the total reflection condition. The scattering regions 31 are located at the positions corresponding to the barrier sections 51 of the parallax barrier 5 and thus do not allow entering of the second illumination light L2 (FIG. 2 and FIG. 7) from the second light source 4. In order to prevent the second illumination light L2 coming from the second light source 4 from entering into the scattering regions 31, the surface of the barrier section 51 of the parallax barrier 5 and the scattering region 31 are desired to be as close to each other as possible. Further, in order to prevent the second illumination light L2 from leaking from the opening sections 52 of the parallax barrier 5 and entering into the scattering regions 31, the size of each of the scattering regions 31 in the in-plane direction is desired to be small to the extent of avoiding interference with each of the opening sections 52. For this reason, the size of each of the scattering regions 31 in the in-plane direction is desired to be about equal to or smaller than that of each of the barrier sections 51.

### [Specific Configurational Example of Scattering Region 31]

FIG. 4A illustrates a first configurational example of the second inner reflective surface 3B in the light-guiding plate 3. FIG. 4B schematically illustrates a reflected state and a scattered state of rays at the second inner reflective surface 3B in the first configurational example illustrated in FIG. 4A. In the first configurational example, a scattering region 31A concave relative to the transparent region 32 is provided as the scattering region 31. Such a concave scattering region 31A may be formed by, for example, sandblasting or laser processing. For instance, the scattering region 31A may be formed by subjecting the surface of the light-guiding plate 3 to specular working and then, subjecting a part corresponding to the scattering region 31A to laser processing. In the case of the first configurational example, the total internal reflection of the first illumination light L11 from the first light source 2 entering at the incident angle θ1 meeting the total reflection condition is caused in the transparent region 32 at the second inner reflective surface 3B. On the other hand, at the concave scattering region 31A, even if the rays of the first illumination light L12 enter at the same incident angle θ1 as that in the transparent region 32, part of the entering rays does not meet the total reflection condition at a side face part 33 in the concave shape, and a part of the incident rays passes through while scattering, whereas the rest is reflected and scattered. Part or all of the reflected and scattered rays is allowed to go to the first inner reflective surface 3A, as the rays with no satisfaction of the total reflection condition.

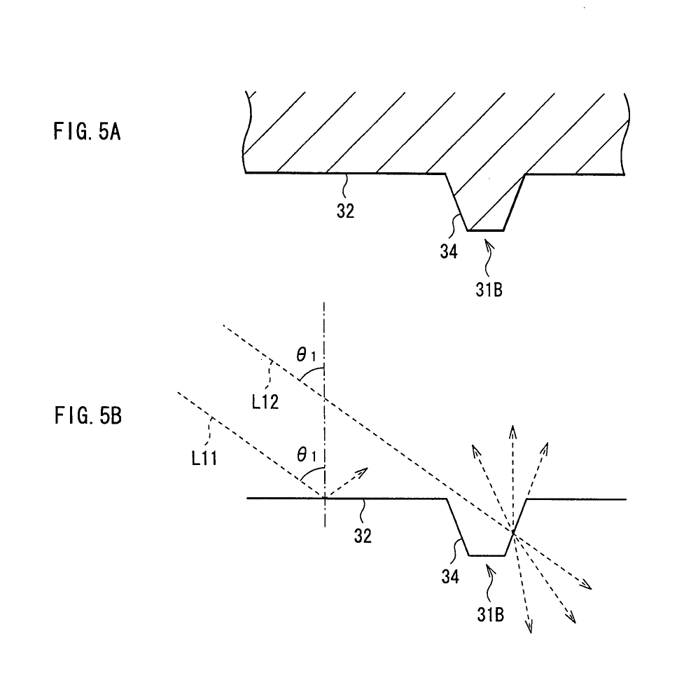

FIG. 5A illustrates a second configurational example of the second inner reflective surface 3B in the light-guiding plate 3. FIG. 5B schematically illustrates a reflected state and a scattered state of rays at the second inner reflective surface 3B in the second configurational example illustrated in FIG. 5A. In the second configurational example, a scattering region 31B convex relative to the scattering region 31 is provided as the transparent region 32. Such a convex scattering region 31B may be formed, for example, by subjecting the surface of the light-guiding plate 3 to molding with a die. In this case, a part corresponding to the transparent region 32 is subjected to specular working by a surface of the die. In the case of the second configurational example, at the second inner reflective surface 3B, the total internal reflection of the first illumination light L11 from the first light source 2 entering at the incident angle θ1 meeting the total reflection condition is caused in the transparent region 32. On the other hand, at the convex scattering region 31B, even if the rays of the first illumination light L12 enter at the same incident angle θ1 as that in the transparent region 32, part of the entering rays does not meet the total reflection condition at a side face part 34 of the convex shape, and a part of the incident rays passes through while scattering, whereas the rest is reflected and scattered. Part or all of the reflected and scattered rays is allowed to go to the first inner reflective surface 3A, as the rays with no satisfaction of the total reflection condition.

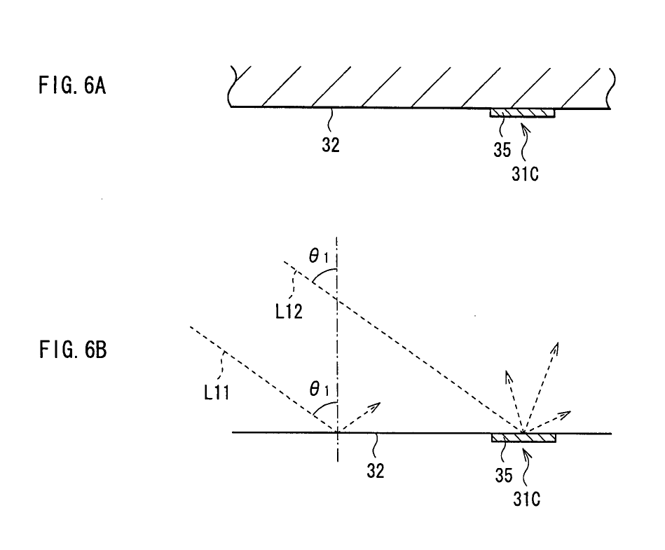

FIG. 6A illustrates a third configurational example of the second inner reflective surface 3B in the light-guiding plate 3. FIG. 6B schematically illustrates a reflected state and a scattered state of rays in the second inner reflective surface 3B in the third configurational example illustrated in FIG. 6A. In the configurational examples of FIG. 4A and FIG. 5A, the scattering region 31 is formed through processing the surface of the light-guiding plate 3 into a shape different from that of the transparent region 32. In contrast, a scattering region 31C in the configurational example of FIG. 6A is not formed through processing the surface, and instead formed through providing a light scattering member 35 made of a material different from that of the light-guiding plate 3, on the surface of the light-guiding plate 3 corresponding to the second inner reflective surface 3B. In this case, the scattering region 31C may be formed, for example, by performing patterning of a white coating (e.g., barium sulfate) on the surface of the light-guiding plate 3 by screen printing, to provide the light scattering member 35. In the case of the third configurational example, at the second inner reflective surface 3B, the total internal reflection of the first illumination light L11 from the first light source 2 entering at the incident angle θ1 meeting the total reflection condition is caused in the transparent region 32. On the other hand, at the scattering region 31C where the light scattering member 35 is disposed, even if the rays of the first illumination light L12 enter at the same incident angle θ1 as that in the transparent region 32, the entering rays are reflected and scattered by the light scattering member 35. Part or all of the reflected and scattered rays is allowed to go to the first inner reflective surface 3A, as the rays with no satisfaction of the total reflection condition.

### [Operation of Stereoscopic Display Apparatus]

When the display in the three-dimensional display mode is performed in the stereoscopic display apparatus, an image based on the three-dimensional image data is displayed in the display section 1, and the on-off (lighting and non-lighting) control of the first light source 2 and the second light source 4 is performed for the three-dimensional display. Specifically, as illustrated in FIG. 2, the first light source 2 is controlled to be in the OFF (non-lighting) state, and the second light source 4 is controlled to be in the ON (lighting) state. In this case, the second illumination light L2 from the second light source 4 passing through the opening sections 52 of the parallax barrier 5 passes through the transparent regions 32 of the light-guiding plate 3 as it is as the rays having directivity, and is allowed to go outside the light-guiding plate 3 as the rays with no satisfaction of the total reflection condition at the first inner reflective surface 3A. In this way, the rays having the directivity according to the barrier pattern of the parallax barrier 5 enter into the display section 1 to serve as the backlight and thereby, the three-dimensional display in the parallax barrier system is performed. Here, when the second illumination light L2 is scattered for some reason while passing through the light-guiding plate 3, the quality of the three-dimensional display deteriorates. In other words, when the three-dimensional display is performed, the light-guiding plate 3 is desired to be transparent with respect to the second illumination light L2. In the stereoscopic display apparatus, the positions of the opening sections 52 of the parallax barrier 5 are aligned with the positions of the transparent regions 32 of the light-guiding plate 3, and the size of each of the scattering region 31 is made small to the extent of avoiding the interference with the opening of the opening section 52. As a result, a transparent state with respect to the second illumination light L2 from the second light source 4 is realized even though the scattering regions 31 are provided.

On the other hand, when the display in the two-dimensional display mode is performed, an image based on the two-dimensional image data is displayed in the display section 1, and the on-off (lighting and non-lighting) control of the first light source 2 and the second light source 4 is performed for the two-dimensional display. Specifically, for example, as illustrated in FIG. 7, both the first light source 2 and the second light source 4 are controlled to be in the ON (lighting) state. In this case, part or all of the first illumination light L12 of the first light source 2 is scatted in the scattering regions 32 of the light-guiding plate 3, and thereby allowed to go outside the light-guiding plate 3 as the rays with no satisfaction of the total reflection condition, from the almost entire surface of the first inner reflective surface 3A. At the same time, the second illumination light L2 from the second light source 4 passing through the opening sections 52 of the parallax barrier 5 passes through the transparent regions 32 of the light-guiding plate 3 as it is, and is allowed to go outside the light-guiding plate 3 as the rays with no satisfaction of the total reflection condition at the first inner reflective surface 3A. As a result, the rays go out from the entire first inner reflective surface 3A in the light-guiding plate 3. In other words, the light-guiding plate 3 functions as a surface light source similar to a usual backlight. Thus, equivalently, the two-dimensional display in a backlight system in which a usual backlight is disposed on a rear side of the display section 1 is performed.

Incidentally, the illumination light L12 goes out from the almost entire surface of the light-guiding plate 3 even when only the first light source 2 is lighted, but the luminance decreases at positions corresponding to the transparent regions 32. This decrease may be corrected by the second illumination light L2 from the second light source 4, and the luminance of rays going out from the light-guiding plate 3 becomes approximately uniform by this correction. However, in the case where the two-dimensional display is performed, when the decrease in the luminance due to the transparent regions 32 may be corrected in other parts, only the first light source 2 may be in the ON (lighting) state, and the second light source 4 may be in the OFF (non-lighting) state. For example, when the decrease in the luminance may be sufficiently corrected in the display section 1, the second light source 4 may be in the OFF (non-lighting) state.

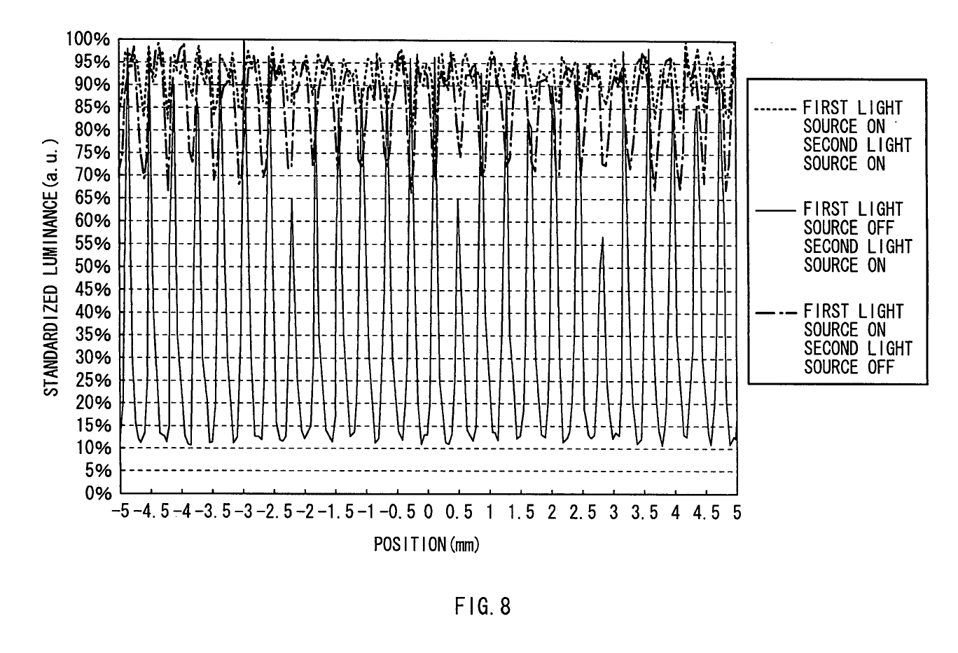

FIG. 8 illustrates an example of luminance distribution observed when the ON (lighting) and OFF (non-lighting) states of the first light source 2 and the second light source 4 are variously changed in the light source device of the stereoscopic display illustrated in FIG. 1. The horizontal axis of FIG. 8 represents the horizontal position (mm) on an observation surface, and the vertical axis represents standardized luminance levels (arbitrary unit (a.u.)).

The luminance distribution has been observed for each of the following three states (1) to (3) each of which is the state of the light source. The states (1) and (3) are ON corresponding to the two-dimensional display, and the state (2) is ON corresponding to the three-dimensional display. As apparent from FIG. 8, in the case of (1), uniform luminance is achieved over the almost entire surface. In the case of (3), high luminance is achieved over the entire surface although the luminance partially decreases as compared to (1). In the case of (2), luminance changes depending on the position, and the luminance distribution corresponding to the barrier pattern of the parallax barrier 5 is achieved.
(1) Both the first light source 2 and the second light source 4 are in the ON (lighting) state.
(2) The first light source 2 is in the OFF (non-lighting) state, and the second light source 4 is in the ON (lighting) state.
(3) The first light source 2 is in the ON (lighting) state, and the second light source 4 is in the OFF (non-lighting) state.

As described above, according to the stereoscopic display apparatus using the light source device of the present embodiment, the scattering regions 31 and the scattering regions 32 are provided on the second inner reflective surface 3B of the light-guiding plate 3, and the first illumination light L12 by the first light source 2 and the second illumination light L2 by the second light source 4 are allowed to go outside the light-guiding plate 3 selectively. Therefore, illumination light for the two-dimensional display and illumination light for the three-dimensional display may be selectively obtained, while a reduction in the utilization rate of light is prevented. This allows the switching between the two-dimensional display and the three-dimensional display, while preventing a reduction in the utilization rate of light, without causing deterioration in the display quality.

The present application contains subject matter related to that disclosed in Japanese Priority Patent Application JP 2010-144972 filed in the Japan Patent Office on Jun. 25, 2010, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof

What is claimed is:

1. A light source device comprising:
a light-guiding plate having a first inner reflective surface and a second inner reflective surface which faces the first inner reflective surface, the second inner reflective surface including a transparent region which causes total internal reflection of the first illumination light and allows the second illumination light to pass therethrough, and including a scattering region causing scatter reflections of the first illumination light;
a first light source emitting first illumination light to allow the first illumination light to enter the light-guiding plate from a side surface thereof;
a parallax barrier disposed to face the second inner reflective surface of the light-guiding plate; and
a second light source disposed to face the second inner reflective surface of the light-guiding plate with the parallax barrier in between, and emitting second illumination light.

2. The light source device according to claim 1, wherein the light-guiding plate allows rays which are out of a total internal reflection condition to pass through the first inner reflective surface to outside, and
the scattering region allows the first illumination light to come to the first inner reflective surface and to behave as the rays which are out of the total internal reflection condition.

3. The light source device according to claim 2, wherein the transparent region allows the second illumination light coming from outside to the second inner reflective surface to pass therethrough, and allows the second illumination light to come to the first inner reflective surface and to behave as the rays with no satisfaction of the total reflection condition.

4. The light source device according to claim 1, wherein the parallax barrier has an opening section which allows light to pass therethrogh and a barrier section which blocks the light,
the transparent region is disposed at a position corresponding to the opening section of the parallax barrier, and
the scattering region is disposed at a position corresponding to the barrier section of the parallax barrier.

5. The light source device according to claim 1, wherein the scattering region is formed through processing a surface of the light-guiding plate which corresponds to the second inner reflecting surface into a shape different from that of the transparent region.

6. The light source device according to claim 1, wherein the scattering region is formed through providing a light scattering member made of a material different from that of the light-guiding plate, on a surface of the light-guiding plate corresponding to the second inner reflective surface.

7. A light source device comprising:
a light-guiding plate having a first inner reflective surface and a second inner reflective surface which faces the first inner reflective surface, the second inner reflective surface including a scattering region causing scatter reflections of the first illumination light from the first light source;
a parallax barrier disposed to face the second inner reflective surface of the light-guiding plate; and
a first light source disposed on a side of the light-guiding plate;
a second light source disposed to face the second inner reflective surface of the light-guiding plate with the parallax barrier in between.

8. The light source device according to claim 7, wherein the parallax barrier has an opening section which allows light to pass therethrough and a barrier section which blocks the light, and
the scattering region is disposed at a position corresponding to the barrier section of the parallax barrier.

9. A display apparatus comprising:
a display section performing image display; and
a light source device emitting light for the image display toward the display section,
wherein the light source device includes
a light-guiding plate having a first inner reflective surface and a second inner reflective surface which faces the first inner reflective surface, the second inner reflective surface including a transparent region which causes total internal reflection of the first illumination light and allows the second illumination light to pass therethrough, and including a scattering region causing scatter reflections of the first illumination light;
a first light source emitting first illumination light to allow the first illumination light to enter the light-guiding plate from a side surface thereof;
a parallax barrier disposed to face the second inner reflective surface of the light-guiding plate; and
a second light source disposed to face the second inner reflective surface of the light-guiding plate with the parallax barrier in between, and emitting second illumination light.

10. The display apparatus according to claim 9, wherein the display section selectively switches between a three-dimensional image based on three-dimensional image data and a two-dimensional image based on two-dimensional image data, to display the selected image,
the first light source is controlled to be OFF when the three-dimensional image is displayed in the display section, and controlled to be ON when the two-dimensional image is displayed in the display section, and
the second light source is controlled to be ON when the three-dimensional image is displayed in the display section, and controlled to be OFF or ON when the two-dimensional image is displayed in the display section.
